(19) United States
(12) Patent Application Publication
(10) Pub. No.: US 2019/0265676 A1
(43) Pub. Date: Aug. 29, 2019

(54) SYSTEMS AND METHODS FOR IMPLEMENTING FEEDBACK FOR FACTORY AUTOMATED DEVICES

(71) Applicant: Mitsubishi Electric Corporation, Chiyoda-ku (JP)

(72) Inventor: Sadashi ONISHI, Vernon Hills, IL (US)

(73) Assignee: Mitsubishi Electric Corporation, Chiyoda-ku (JP)

(21) Appl. No.: 15/908,172

(22) Filed: Feb. 28, 2018

(51) Int. Cl. G05B 19/4068; G05B 19/4065; G05B 19/401; G05B 19/408; G05B 19/4155

(52) U.S. Cl. CPC G05B 19/4068; G05B 19/4065; G05B 19/4155; G05B 19/408; G05B 19/4015

(57) ABSTRACT

A system for implementing factory automated device feedback includes a factory automated device and a translation server communicably coupled to die factory automated device by a network. The translation server includes processing circuitry configured to receive data analysis results from a data analysis server, translate the data analysis results to a programming language of the factory automated device, generate one or more function blocks based on the translation of the data analysis results. The one or more function blocks are generated in the programming language of the factory automated device, and output the one or more function blocks. The one or more function blocks are configured to be implemented in the factory automated device.

### FIELD OF THE DISCLOSURE

The present disclosure relates to a system and associated methodology for implementing feedback for factory automated devices.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Factory automation has become increasingly sophisticated in replacing difficult physical and/or monotonous work, performing tasks in hazardous environments, and performing tasks beyond human capabilities with faster production and cheaper labor costs. The factory automation can be performed by factory automated devices, and manufacturing data is typically analyzed to provide feedback to the factory automated devices. The data analysis site and the manufacturing site are typically in different locations, and the results of the complex data analysis can be difficult to implement at the manufacturing site due to a disconnect in location, as well as a disconnect between people with different skill sets.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

According to embodiments of the disclosed subject matter, a system for implementing factory automated device feedback includes a factory automated device and a translation server communicably coupled to the factory automated device by a network. Additionally, the translation server includes processing circuitry configured to receive data analysis results from a data analysis server, translate the data analysis results to a programming language of the factory automated device, generate one or more function blocks based on the translation of the data analysis results, wherein the one or more function blocks are generated in the programming language of the factory automated device, and Output the one or more function blocks, wherein the one or more function blocks are configured to be implemented in the factory automated device.

A method for implementing factory automated device feedback, including receiving, via processing circuitry, data analysis results from a data analysis server; translating, via the processing circuitry, the data analysis results to a programming language of a factory automated device; generating, via the processing circuitry, one or more function blocks based on the translation of the data analysis results, wherein the one or more function blocks are generated in the programming language of the factory automated device; and outputting, via the processing circuitry, the one or more function blocks, wherein the one or more function blocks are configured to be implemented in the factory automated device.

A non-transitory computer-readable storage medium that, when executed by a computer, causes the computer to perform a method for implementing factory automated device feedback, including receiving data analysis results from a data analysis server; translating the data analysis results to a programming language of a factory automated device; generating one or more function blocks based on the translation of the data analysis results, wherein the one or more function blocks are generated in the programming language of the factory automated device; and outputting the one or more function blocks, Wherein the one or more function blocks are configured to be implemented in the factory automated device.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts an exemplary factory automated device feedback workflow according to one or more aspects of the disclosed subject matter;

FIG. 2 depicts an exemplary overview of a factory automated device feedback system according to one or more aspects of the disclosed subject matter;

FIG. 3 depicts an exemplary translation server according to one or more aspects of the disclosed subject matter;

FIG. 4 depicts an exemplary interface according to one or more aspects of the disclosed subject matter;

FIG. 5A is an algorithmic flowchart of a method for implementing feedback for a factory automated device according to one or more aspects of the disclosed subject matter;

FIG. 5B depicts an exemplary ladder logic diagram according to one or more aspects of the disclosed subject matter;

FIG. 6 is an algorithmic flowchart of a method for translating results of manufacturing analytics according to one or more aspects of the disclosed subject matter;

FIG. 7 is an algorithmic flowchart of a method for generating function blocks according to one or more aspects of the disclosed subject matter;

FIG. 8A is an algorithmic flowchart of a method for generating customized function blocks according to one or more aspects of the disclosed subject matter;

FIG. 8B depicts an exemplary ladder logic diagram according to one or more aspects of the disclosed subject matter; and

FIG. 9 is a hardware block diagram of a server according to one or more exemplary aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed. subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations andlor functions as described herein, and likewise do not necessarily limit embodiments of the disclosed subject matter to any particular configuration or orientation.

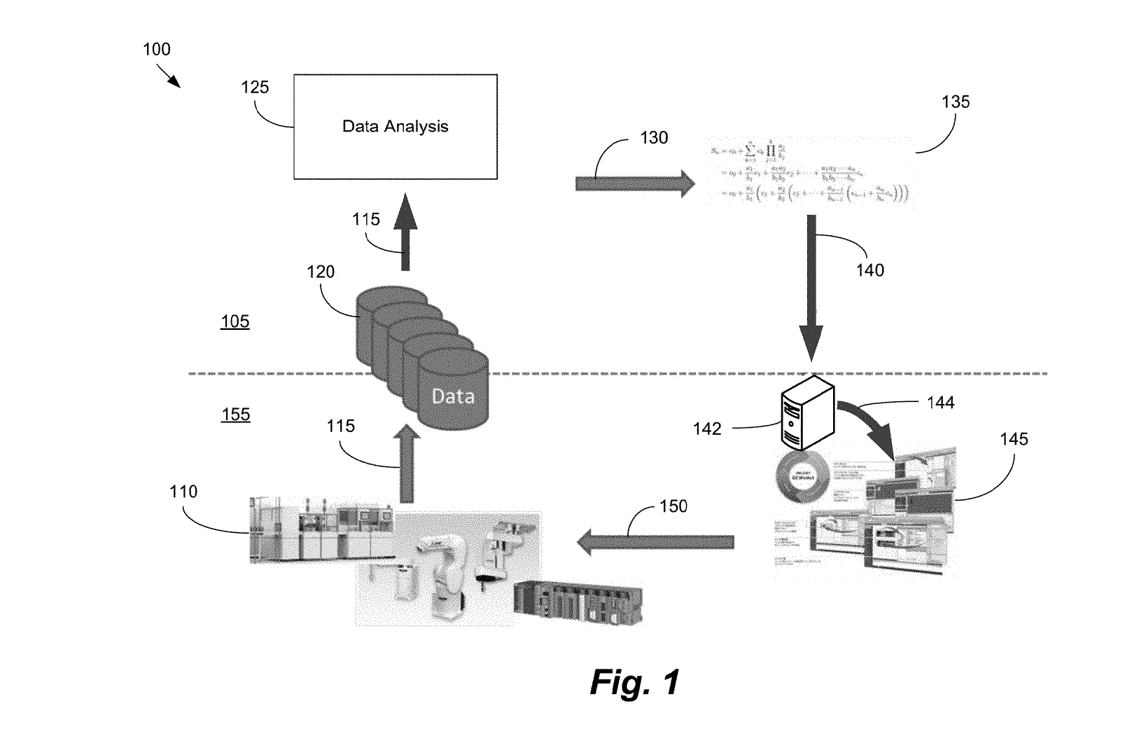

Referring now to the drawings, wherein like reference numerals designate identical or corresponding parts throughout the several views, FIG. 1 depicts an exemplary factory automated device feedback workflow 100 according to one or more aspects of the disclosed subject matter. Generally, the factory automated device feedback workflow 100 illustrates implementing feedback in the form of data analysis into control programs of factory automated devices, such as programmable logic controllers (PLC), using interfaces configured to receive user input. With data analysis typically being performed at a different location than the manufacturing site where the results of the analysis are implemented, a disconnect can arise when knowledge of both data analytics and the manufacturing site are needed to implement the feedback effectively. However, few people have knowledge of both, so analyzing the results of the data analysis and. installing the results of the data analysis into the factory automated devices at the manufacturing site can be difficult. As a result, the factory automated device feedback workflow 100 illustrates a solution including a translation server 142 that can act as a bridge between the complex results of the data analysis and implementing the feedback in the factory automated devices by generating easy to implement. function blocks (e.g., anomaly detection, predictive diagnosis, etc.) into control programs of the factory automated devices. Additionally, the translation server 142 can facilitate (e.g., based on user input) generation of function blocks for countermeasures for events including anomalies and/or faults.

More specifically, in the factory automated device feedback workflow 100, arrow 115 indicates that manufacturing data 120 can be transmitted from one or more factory automated devices 110 to a data analysis site 105 for data analysis 125. In one implementation, the data analysis 125 is performed by Statistica from TWO and/or RapidMiner Studio from RapidMiner, which are incorporated by reference herein in their entirety. Arrow 130 indicates data analysis 125 can generate data analysis results 135. Arrow 140 indicates that the data analysis results 135 can be transmitted to the translation server 142. Arrow 144 indicates that the translation server 142 can output translation results 145 corresponding to output function blocks that have been translated into the factory automated device's 110 programming language. Arrow 150 indicates that the translation results 145 corresponding to the function blocks can be installed into the factory automated devices 110.

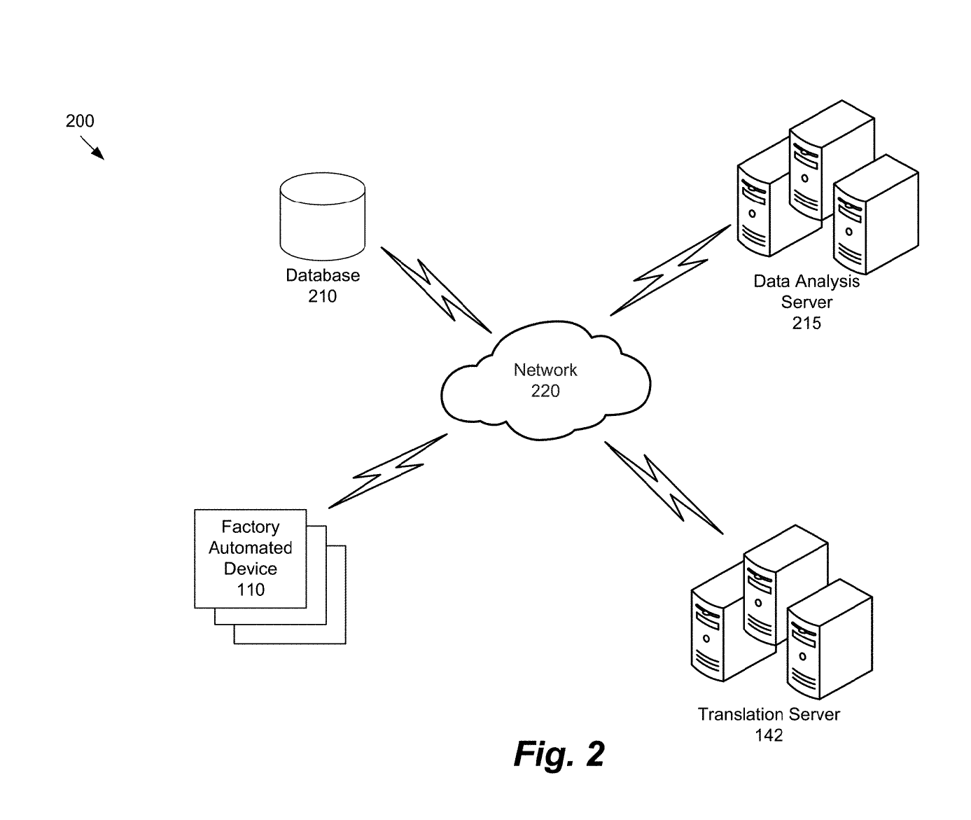

FIG. 2 depicts an exemplary overview of a factory automated device feedback system 200 according to one or more aspects of the disclosed subject matter. The factory automated device feedback system 200 (herein referred to as system 200) can include one or more factory automated devices 110, a database 210, one or more data analysis servers 215, and one or more translation servers 142 communicably coupled via a network 220.

The factory automated device 110 can represent one or more factory automated devices connected to the database 210, the data analysis server 215, and the translation server 142 via the network 220. The factory automated device 110 can be any device for factory automation (e.g., industrial robot, industrial machine, etc.). The factory automated device 110 can include a PLC which can receive control programs as function blocks that are configured to implement feedback from data analysis results.

The database 210 can represent one or more databases connected to the factory automated device 110, the data analysis server 215, and the translation server 142 via the network 220. The database 210 can be configured to store look up tables and/or libraries for translating the data analysis results into function blocks of the factory automated device's 110 programming language. Additionally, the database 210 can be configured to store customized interfaces, control programs, and/or function blocks which can be implemented in response to predetermined manufacturing situations (e.g., anomaly detection), as further described herein.

The data analysis server 215 can represent one or more data analysis servers connected to the factory automated device 110, the database 210, and the translation server 142 via the network 220. For example, the data analysis server 215 can be used by data scientists to analyze the manufacturing data 120 (e.g., operation status, operation data, etc.). More specifically, the data analysis server 215 can be configured to perform data analysis on the manufacturing data 120 received from the factory automated devices 110, and output the data analysis results. The data analysis server 215 can also be configured to transmit the results of the data analysis to the translation server 142 at the manufacturing site 155. In other words, the data analysis server 215 can represent any analysis and processing performed by the data scientists when analyzing the manufacturing data 120 received from the factory automated devices 110.

The translation server 142 can represent one or more translation servers connected to the factory automated device 110, the database 210, and the data analysis server 215 via the network 220. The translation server 142 can include processing circuitry to perform various processing for the system 200 including receiving data analytics results from the data analysis server, identifying syntax from the data analysis results, translating the data analysis results into the factory automated device's 110 programming language, generating function blocks, and outputting the function blocks that can be easily integrated into the factory automated devices (e.g., in control programs of the PLC). In other words, the translation server 142 can be a bridge between the complex data analysis and the manufacturers at the manufacturing site 155. The translation server 142 can be located at the manufacturing site 155 such that manufacturers at the manufacturing site 155 can interact with (e.g., via a display) the translation server and customize the fiinction blocks according to various manufacturing scenarios, as will be further described herein.

For example, if there is manufacturing data indicating that there is a relationship such that when a parameter “A” is greater than 50, then the products being manufactured will not be of sufficient quality, then data analysis can provide algorithms (e.g., data analysis results) for resolving the manufacturing issue. Manufacturers need to implement the data analysis results into the factory automated devices, as well as incorporating alarms and setting a threshold to prevent low quality products from being manufactured. Further, these manufacturing remedies may he different for different manufacturers including different thresholds, how the alarm occurs, the specific messages displayed, what recommended measures the manufacturer should take, and the like. The translation server 142 can provide a solution to the complexity of implementing the data analysis results by providing function blocks in the factory automated device's 110 programming language which can provide easy installation for the manufacturers. Additionally, the function blocks can monitor parameters relating to quality, as well as alert andior notify the manufacturers when the parameters exceed predetermined thresholds. Further, the translation server 142 can be configured to receive input from the manufacturer to configure the monitoring parameters, the alarms, and the messaging via an interface, for example, and the translation server 142 can generate function blocks based on the manufacturer's configuration.

The network 220 can represent one or more networks connecting the factory automated device 110, the database 210, the data analysis server 215, and the translation server 142. The network 220 can be a public network, such as the Internet, a private network such as a local area network (LAN) or a wide area network (WAN) network, or any combination thereof and can also include a public switched telephone network (PSTN) or integrated services for digital network (ISDN) sub-networks. The network 220 can also be wired, such as an Ethernet network or a USB port, or can be wireless such as a cellular network including EDGE, 3G 4G, and LTE/LTE-A wireless cellular systems. The wireless network can also be Wi-Fi, Bluetooth, or any other wireless form of communication that is known.

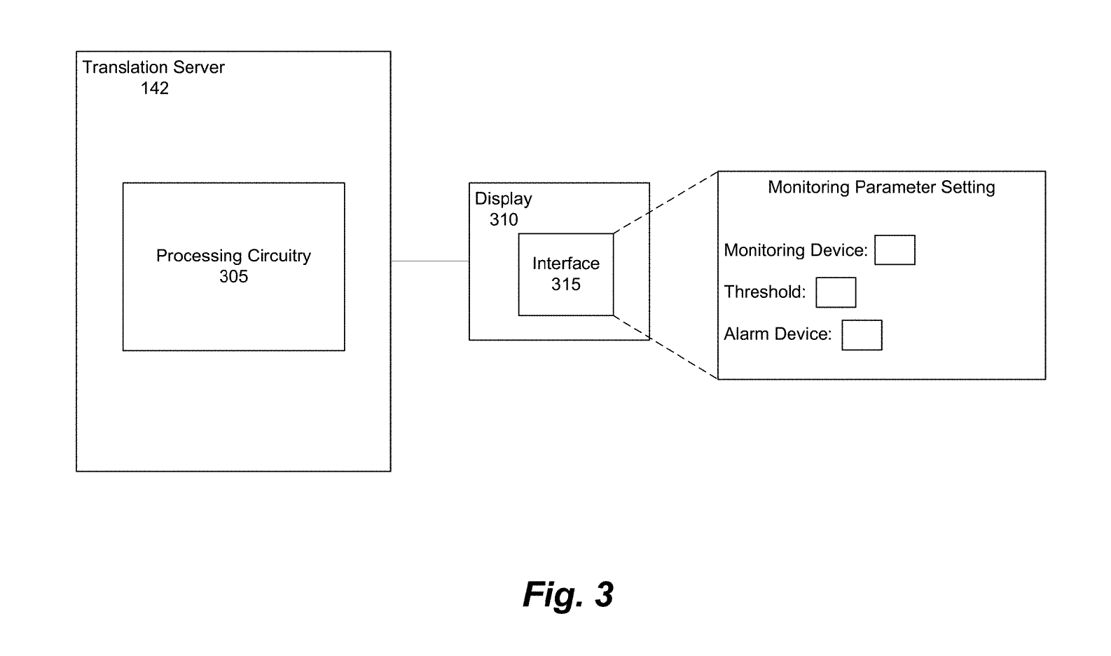

FIG. 3 depicts the translation server 142 in an exemplary embodiment according to one or more aspects of the disclosed subject matter. The translation server 142 can include processing circuitry 305, wherein the processing circuitry 305 can be configured to receive data analytics results from the data analysis server 215, identify syntax from the data analysis results, translate the data analysis results into the factory automated device's 110 programming language, generate function blocks, output the function blocks, and the like. The translation server 142 can be communicably coupled to a display 310. The display 310 can include an interface 315, such as a digital and/or physical keyboard and/or a mouse and/or touch-based input functionality, allowing an operator, for example, to interact with the translation server 142. In one embodiment, the interface 315 can be configured to receive input for monitor parameter setting including receiving input regarding a monitoring device, a threshold, and an alarm device.

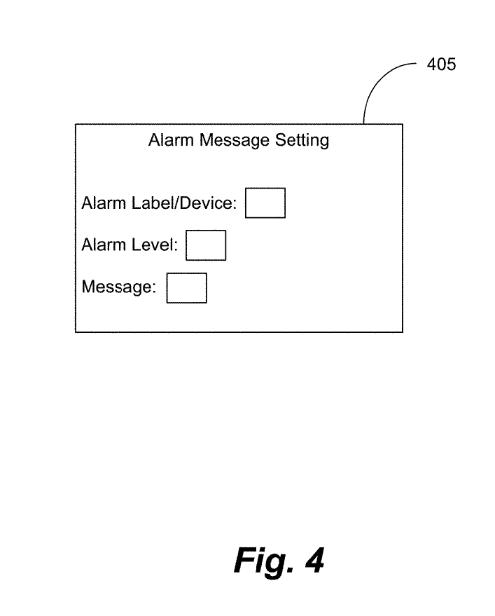

In one embodiment, FIG. 4 depicts an interface 405 that can be displayed via the display 310, wherein the interface 405 can be configured to receive input for alarm message setting including receiving input regarding an alarm label/device, an alarm level, and a message.

Referring again to FIG. 3, the processing circuitry 305 can also be configured to receive input via the interface 315, wherein the interface 315 is customizable by the manufacturers who can configured the interface 315 based on the factory automated devices they have, the various problems that arise with those devices, and the like. For example, the customizable interfaces can facilitate generation of function blocks for countermeasures for events including anomalies and/or faults. Further, the processing circuitry 305 can be configured to receive indication via the interface to store customized control programs, function blocks, and/or interfaces in the database 210, for example.

It should be appreciated the interfaces depicted in FIG. 3 and FIG. 4 are exemplary, and other interfaces and other input options can be displayed in various templates that may be more relevant for different manufacturers and/or different types of factory automated devices.

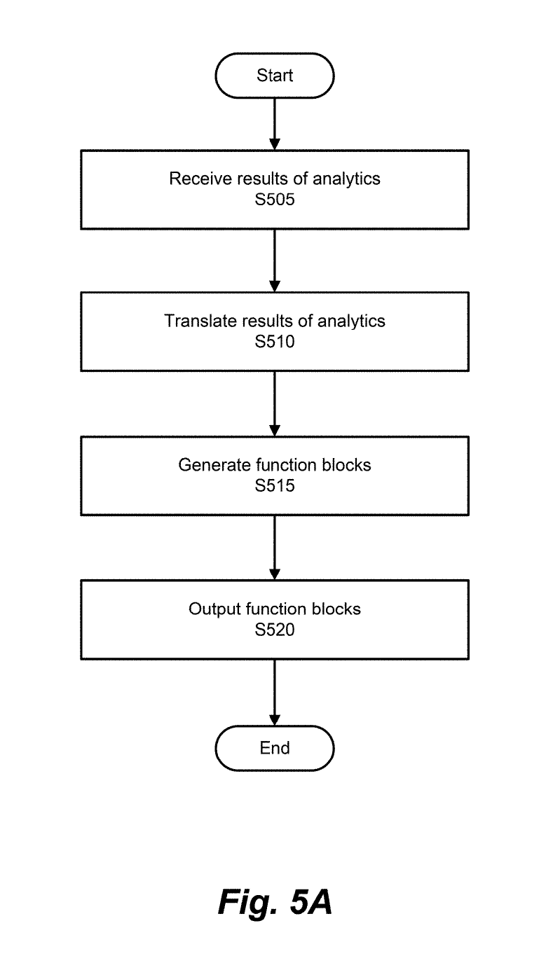

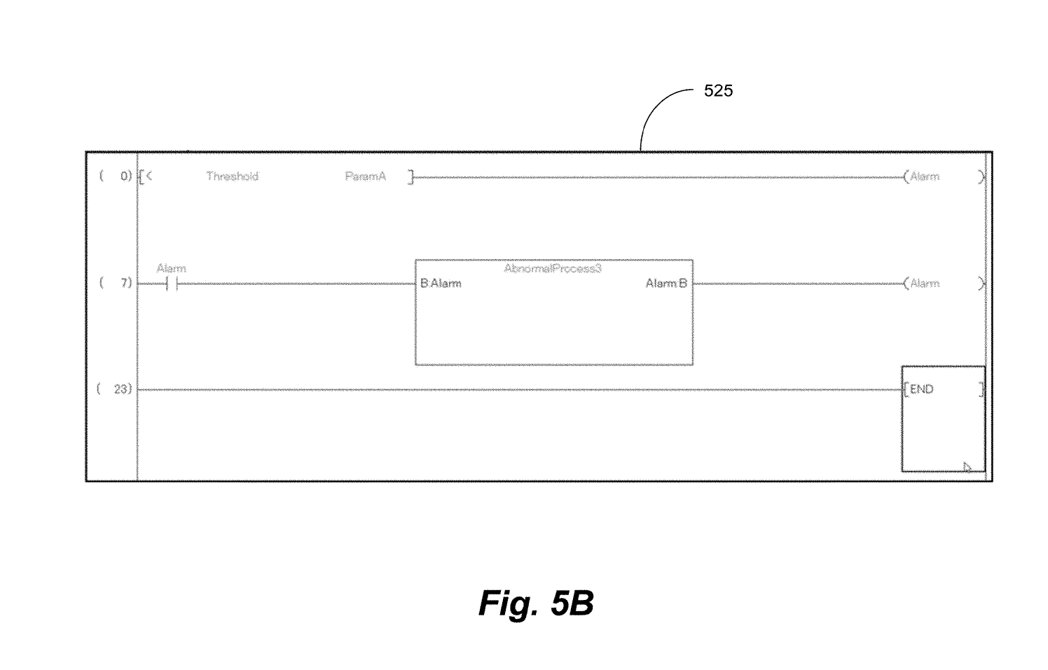

FIG. 5A is an algorithmic flowchart of a method for implementing feedback for the factory automated device 100 according to one or more aspects of the disclosed subject matter.

In S505, results of analytics can be received at the translation server 142 from the data analysis server 215. The results of analytics can correspond to the data analysis results from analyzing the manufacturing data 120 from the factory automated device 110.

In S510, the data analysis results can be translated into the factory automated device's 100 programming language (e.g., Ladder, function block diagram (FBD), etc.). The data analysis results can be translated by recognizing the syntax of the algorithms that correspond to the data analysis results, and using a look up table and/or libraries to translate the data analysis results to the factory automated device's 110 programming language.

In S515, the function blocks can be generated. Generating the function blocks can include receiving input from the manufacturers (e.g., via the interface 315) and generating a control program based on the received input corresponding to a function block that can be easily implemented into the factory automated device's 110 PLC.

In S520, the function blocks can be output from the translation server 142. The output function blocks can then be integrated into the factory automated device 110, for example. After the function block is output from the translation server 142, the process ends.

FIG. 5B depicts an exemplary ladder logic diagram 525 according to one or more aspects of the disclosed subject matter. The ladder logic diagram 525 is an example of the results of the translation in S510 where syntax from the data analysis results can be recognized and translated into the programming language of the factory automated device 110. For example, the ladder Logic diagram 525 indicates that for a given threshold of a parameter (e.g., ParamA), an alarm can be activated when the given threshold for ParamA is exceeded.

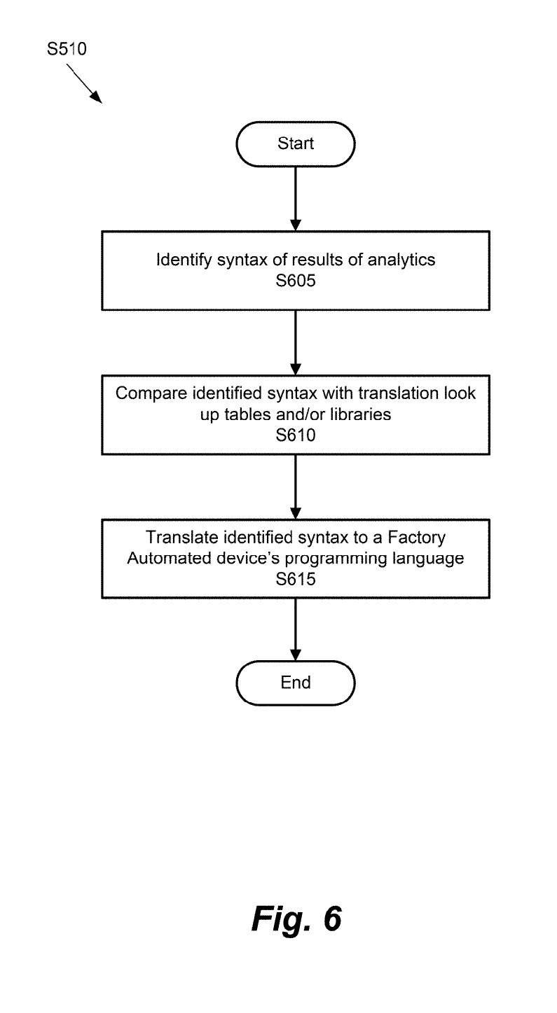

FIG. 6 is an algorithmic flowchart of a method for translating results of manufacturing analytics in S510 according to one or more aspects of the disclosed subject matter. In S605, syntax of the data analysis results can be identified by the translation server 142.

In S610, the translation server 142 can compare the identified syntax with translation look up tables and/or libraries stored in the database 210. For example, the following syntax may be recognized:

if (ParamA > 50) {
// Process for anomaly detected
}

First, the translation server 142 can recognize the “if” statement and parameter in S605, and second, the translation server 142 can refer to look up tables and/or libraries in S610 to translate the algorithm into the factory automated device's 110 programming language in 5615.

In 5615, translation server 142 can translate the identified syntax (e.g., programming language of algorithm corresponding to the data analysis output of the data analysis server 215) to a factory automated device's 110 programming language. After the identified syntax is translated, the process can end.

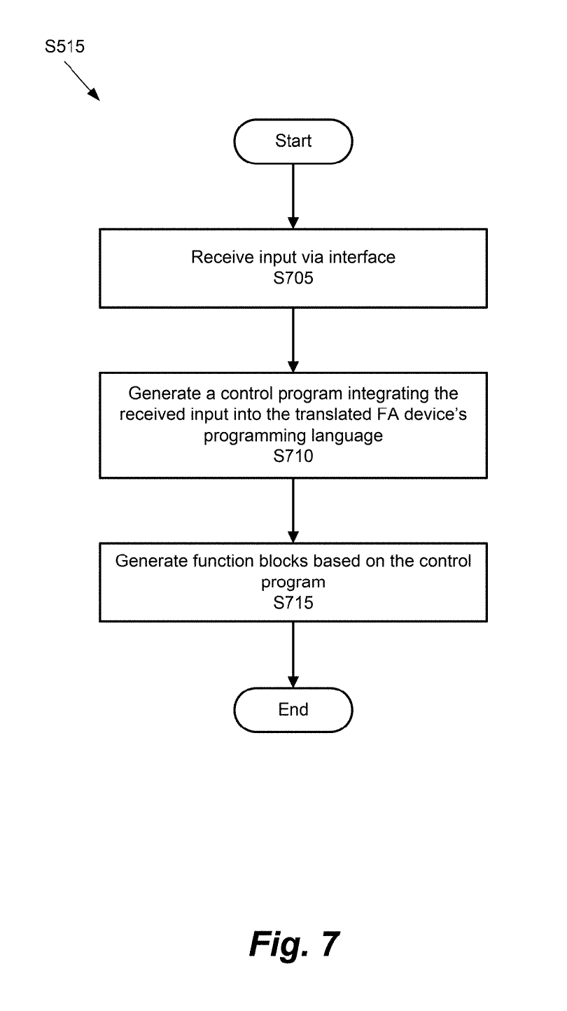

FIG. 7 is an algorithmic flowchart of a method for generating function blocks in S515 according to one or more aspects of the disclosed subject matter.

In S705, the translation server 142 can receive input via the interface (e.g., interface 315 and/or interface 405). The input can include relevant configuration information including the monitor parameter settings (FIG. 3) and the alarm message settings (FIG. 4). Receiving input via the interface allows manufacturers to simply configure the function block relating to items of the specific factory automated device 110 that they are working with, and the manufacturers don't need to know the detail of the data analysis results (i.e., algorithms output by the data analysis server 215).

In S710, the translation server 142 can generate a control program integrating the received input into the previously translated factory automated device's 110 programming language.

In S715, the translation server 142 can generate the function blocks based on the control program generated in S710. The function blocks (e.g., anomaly detection, predictive diagnosis, etc.) having been translated into the factory automated device's 100 programming language and configured using manufacturer's input can be easy to implement into control programs of the factory automated device 110.

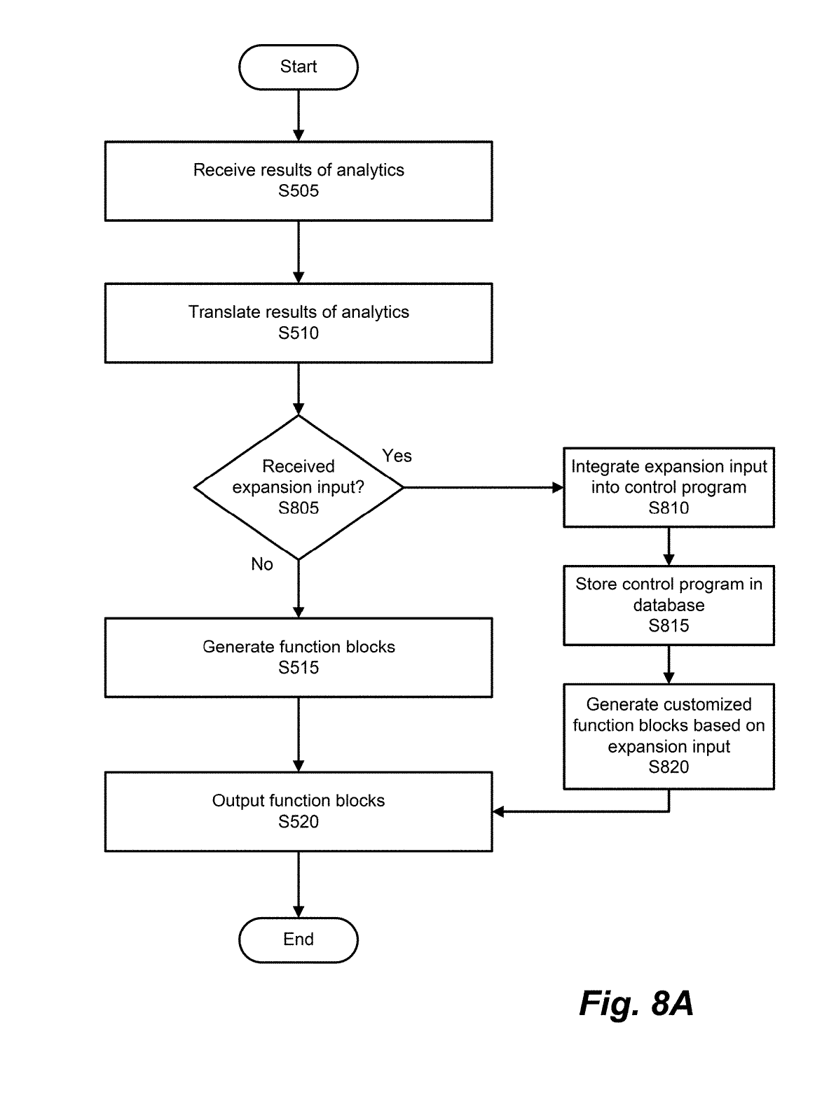

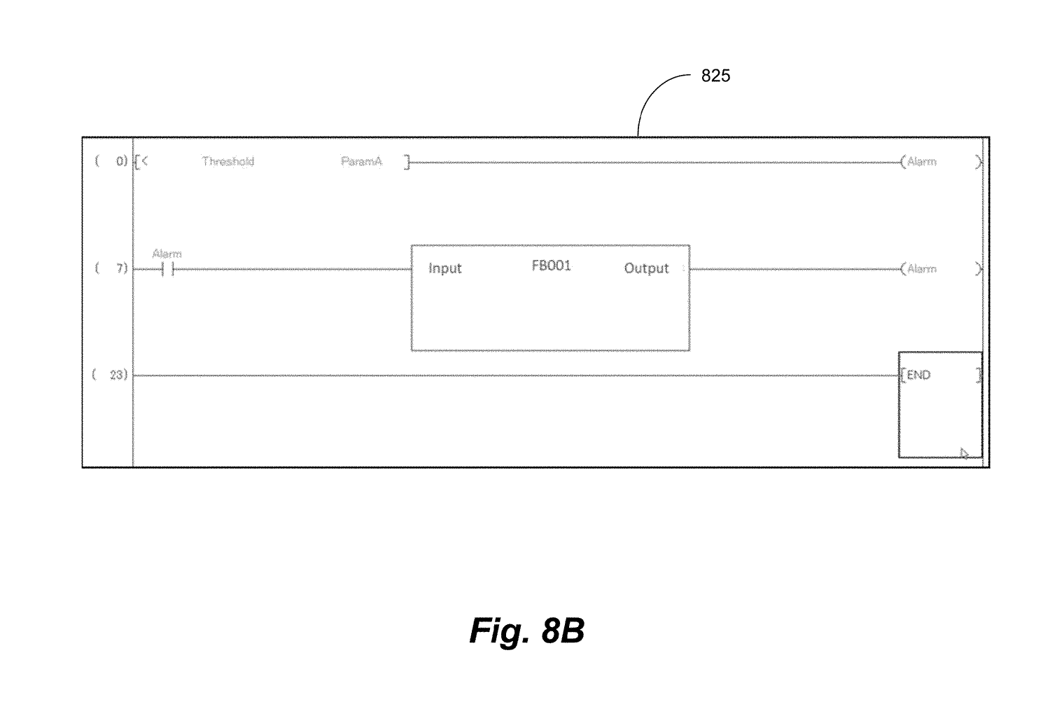

FIG. 8A is an algorithmic flowchart of a method for generating customized function blocks according to one or more aspects of the disclosed subject matter. In FIGS. 8, S505, S510, S515, and S520 can be performed as described in FIG. 5.

In S805, it can be determined if expansion input was received. Expansion input can include customizing the interface based on a template to fit what the manufacturer wants to configure. For example, the default interface may not be sufficient for the needs of the manufacturer, so the manufacturer can integrate expansion input into the control program by customizing the interfaces. If no expansion input was received, the process can continue to generate function blocks in S515 and output function blocks in S520. However, if expansion input was received, then the translation server 142 can integrate the expansion input into the control program of the factory automated device 110 in S810.

In S810, the translation server 142 can integrate the expansion input into the control program. For example, the manufacturer can create a custom interface, and input received from the custom interface can correspond to a custom control program.

In S815, the translation server 142 can store the control program in the database 210.

In S820, the translation server 142 can generate customized function blocks based on the expansion input integrated into the control program. For example, because the customized function block (e.g., <FB001>) was stored in the database 210, the customized function block can be used in response to predetermined identified syntax. For example, the following syntax can be recognized and the stored customized function block can be implemented in response:

```
if (ParamA > 50) {
        // Process for anomaly detected
        <FB001>
}
```

The customized function block can be implemented automatically in response to recognizing predetermined syntax from the data analysis results. In other words, the one or more customized function blocks based on the expansion input can be stored, and the one or more customized function blocks based on the expansion input are automatically implemented when predetermined syntax from the data analysis results is recognized.

The customized function blocks can then be output in S520.

FIG. 8B depicts an exemplary ladder logic diagram 825 according to one or more aspects of the disclosed subject matter. The ladder logic diagram 825 is an example of a previously stored (S815) customized function block being implemented automatically in response to recognizing predetermined syntax from the data analysis results. For example, in the translation step, having access to the previously stored customized function block, the customized function block <FB001> is included in the ladder logic diagram 825 in response recognized syntax indicates that for a given threshold of a parameter (e.g., ParamA), <FB001> can be activated when the given threshold for ParamA is exceeded.

In the above description of FIGS. 5A, 6, 7, and 8A, any processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

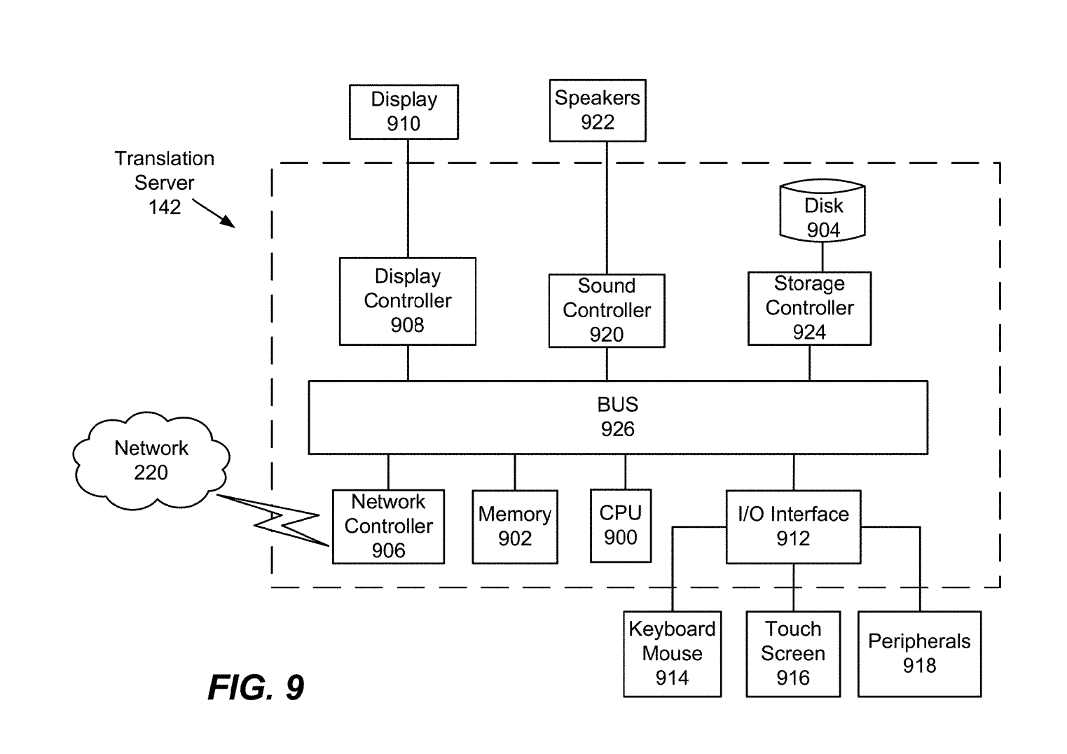

Next, a hardware description of a server (e.g., the translation sever 142) according to exemplary embodiments is described with reference to FIG. 9. The hardware description described herein can also be a hardware description of the processing circuitry 305. In FIG. 9, the translation server 142 includes a CPU 900 which performs one or more of the processes described above/below. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard diSk or any other information processing device with Which the translation server 142 communicates, such as a server or computer.

Further, the claimed advancements may be provided as a utility application, background daemon, or component of an operating system, or combination thereof, executing in conjunction with CPU 900 and an operating system such as Microsoft Windows, UNIX, Solaris, LINUX, Apple MAC-OS and other systems known to those skilled in the art.

The hardware elements in order to achieve the translation server 142 may be realized by various circuitry elements. Further, each of the functions of the above described embodiments may be implemented by circuitry, which includes one or more processing circuits. A processing circuit includes a particularly programmed processor, for example, processor (CPU) 900, as shown in FIG. 9. A processing circuit also includes devices such as an application specific integrated circuit (ASIC) and conventional circuit components arranged to perform the recited functions.

In FIG. 9, the translation server 142 includes a CPU 900 which performs the processes described above. The translation server 142 may be a general-purpose computer or a particular, special-purpose machine. In one embodiment, the translation server 142 becomes a particular, special-purpose machine when the processor 900 is programmed to implement feedback for factory automated devices by translating data analysis results to the factory automated devices programming language and integrating the translated data analysis results into the factory automated devices (and in particular, any of the processes discussed with reference to FIGS. 5-8).

Alternatively, or additionally, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The translation server 142 in FIG. 9 also includes a network controller 906, such as an Intel Ethernet PRO network interface card from Intel Corporation of America, for interfacing with network 220. As can be appreciated, the network 220 can be a public network, such as the Internet, or a private network such as an LAN or WAN network, or any combination thereof and can also include PSTN or ISDN sub-networks. The network 220 can also be wired, such as an Ethernet network, or can be wireless such as a cellular network including EDGE, 3G and 4G wireless cellular systems. The wireless network can also be WiFi, Bluetooth, or any other wireless form of communication that is known.

The translation server 142 further includes a display controller 908, such as a graphics card or graphics adaptor for interfacing with display 910 (or display 310), such as a monitor. A general purpose I/O interface 912 interfaces with a keyboard and/or mouse 914 as well as a touch screen panel 916 on or separate from display 910. General purpose I/O interface also connects to a variety of peripherals 918 including printers and scanners.

A sound controller 920 is also provided in the translation server 142 to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the translation server 142. A description of the general katures and functionality of the display 910, keyboard and/or mouse 914, as well as the display controller 908, storage controller 924, network controller 906, sound controller 920, and general purpose I/O interface 912 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a IAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled. by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. A system, comprising:
a factory automated device; and
a translation server communicably coupled to the factory automated device by a network, wherein the translation server includes a processing circuitry configured to
receive data analysis results from a data analysis server,
translate the data analysis results to a programming language of the factory automated device,
generate one or more function blocks based on the translation of the data analysis results, wherein the one or more function blocks are generated in the programming language of the factory automated device, and
output the one or more function blocks, wherein the one or more function blocks are configured to be implemented in the factory automated device.

2. The system of claim 1, wherein the processing circuitry is further configured to
identify syntax of the data analysis results,
compare identified syntax with one or more of a translation look up table and libraries, and
translate the identified syntax to the programming language of the factory automated device.

3. The system of claim 1, wherein the processing circuitry is further configured to
receive input through an interface, wherein the interface is communicably coupled to the translation server,
generate a control program that integrates the received input into the programming language of the factory automated device, and
generate the one or more function blocks based on the control program including the received input.

4. The system of claim 1, wherein the processing circuitry is further configured to
determine if expansion input is received,
integrate the expansion input into a control program,
store the control program with the integrated expansion input in a database, and
generate the one or more function blocks based on the expansion input, wherein the one or more function blocks are customized based on the expansion input.

5. The system of claim 3, wherein the interface is configured to receive input corresponding to monitoring parameter settings including input for specifying a monitoring device, a threshold, and an alarm device.

6. The system of claim 3, wherein the interface is configured to receive input corresponding to alarm message setting including input for specifying alarm label/device, alarm level, and a message.

7. The system of claim 4, wherein the expansion input is received from customized interfaces, wherein the customized interfaces are configured by a manufacturer.

8. The system of claim 4, wherein the one or more function blocks based on the expansion input are automatically implemented when predetermined syntax from the data analysis results is recognized.

9. A method, comprising:
receiving, via a processing circuitry, data analysis results from a data analysis server;
translating, via the processing circuitry, the data analysis results to a programming language of a factory automated device;
generating, via the processing circuitry, one or more function blocks based on the translation of the data analysis results, wherein the one or more function blocks are generated in the programming language of the factory automated device; and
outputting, via the processing circuitry, the one or more function blocks, wherein the one or more function blocks are configured to be implemented in the factory automated device.

10. The method of claim 9, further comprising:
identifying syntax of the data analysis results;
comparing identified syntax with one or more of a translation look up table and libraries; and
translating the identified syntax to the programming language of the factory automated device.

11. The method of claim 9, further comprising:
receiving input through an interface, wherein the interface is communicably coupled to the processing circuitry;
generating a control program that integrates the received input into the programming language of the factory automated device; and
generating the one or more function blocks based on the control program including the received input.

12. The method of claim 9, further comprising:
determining if expansion input is received;
integrating the expansion input into a control program;
storing the control program with the integrated expansion input in a database; and
generating the one or more function blocks based on the expansion input, wherein the one or more function blocks are customized based on the expansion input,
wherein the one or more function blocks based on the expansion input are automatically implemented when predetermined syntax from the data analysis results is recognized.

13. The method of claim 11, wherein the interface is configured to receive input corresponding to monitoring parameter settings including input for specifying a monitoring device, a threshold, and an alarm device.

14. The method of claim 11, wherein the interface is configured to receive input corresponding to alarm message setting including input for specifying alarm label/device, alarm level, and a message.

15. The method of claim 12, wherein the expansion input is received from customized interfaces, wherein the customized interfaces are configured by a manufacturer.

16. A non-transitory computer-readable storage medium that, when executed by a computer, causes the computer to perform a method, comprising:
receiving data analysis results from a data analysis server;
translating the data analysis results to a programming language of a factory automated device;
generating one or more function blocks based on the translation of the data analysis results, wherein the one or more function blocks are generated in the programming language of the factory automated device; and
outputting the one or more function blocks, wherein the one or more function blocks are configured to be implemented in the factory automated device.

17. The non-transitory computer-readable storage medium of claim 16, further comprising:
identifying syntax of the data analysis results;
comparing identified syntax with one or more of a translation look up table and libraries; and
translating the identified syntax to the programming language of the factory automated device.

18. The non-transitory computer-readable storage medium of claim 16, further comprising:
receiving input through an interface, wherein the interface is communicably coupled to a processing circuitry;
generating a control program that integrates the received input into the programming language of the factory automated device; and
generating the one or more function blocks based on the control program including the received input.

19. The non-transitory computer-readable storage medium of claim 16, further comprising:
determining if expansion input is received;
integrating the expansion input into a control program;
storing the control program with the integrated expansion input in a database; and
generating the one or more function blocks based on the expansion input, wherein the one or more function blocks are customized based on the expansion input,
wherein the one or more function blocks based on the expansion input are automatically implemented when predetermined syntax from the data analysis results is recognized.

20. The non-transitory computer-readable storage medium of claim 19, wherein the expansion input is received from customized interfaces, wherein the customized interfaces are configured by a manufacturer.
